(19) United States
(12) Patent Application Publication
(10) Pub. No.: US 2011/0305520 A1
(43) Pub. Date: Dec. 15, 2011

(54) DIVING ACCESSORY FOR WEIGHT BELT

(76) Inventor: MATTHEW WEST, Commerce, TX (US)

(21) Appl. No.: 13/157,039

(22) Filed: Jun. 9, 2011

Related U.S. Application Data
(60) Provisional application No. 61/353,488, filed on Jun. 10, 2010.

(51) Int. Cl. B63C 11/02; F21V 33/00

(52) U.S. Cl. 405/186; 362/234

(57) ABSTRACT

An embodiment of a weight system for use with a buoyancy compensator device includes a rigid plate, a weight pouch attached to the rigid plate, and an indicator device fixedly interfaced with the rigid plate. The indicator device further includes a freely moving floatation device that floats within a restrained range upward from the rigid plate in response to the weight pouch being separate from the buoyancy compensator device.

### CROSS-REFERENCE TO RELATED APPLICATIONS

This application claims benefit of U.S. Provisional Application No. 61/353,488, filed Jun. 10, 2010, entitled DIVING ACCESSORY FOR WEIGHT SYSTEM (Atty. Dkt. No. WSTM-29,801), the specification of which is incorporated herein in its entirety.

### TECHNICAL FIELD

Embodiments of the invention related to an integrated weight system for use with a buoyancy compensator device, and more particularly, to an integrated weight system having an indicator attached thereto for use with a buoyancy compensator device.

### BACKGROUND

A buoyancy compensator device is a piece of diving equipment worn by divers to provide a desired level of buoyancy while under water. The buoyancy compensator device allows a diver the ability to adjust and control the overall buoyancy of the diver and the diver's equipment to achieve a desired level of buoyancy. The buoyancy compensator device allows the diver to achieve neutral buoyancy, which allows the diver to remain at a constant depth or to either descend or ascend in a controlled manner. One type of buoyancy compensator device is a buoyancy compensator vest. The buoyancy compensator vest is an inflatable vest that includes air bladders, which may either be inflated or deflated. The buoyancy compensator vest is worn around the upper torso of the diver and also acts as a harness to mount a diving cylinder, which contains a source of air for the diver. The diving cylinder provides the air to a diving regulator which is used by the diver to breath while underwater. A buoyancy compensator vest typically has a low-pressure direct feed that transports gas from the diving cylinder and diving regulator to the buoyancy compensator vest, and an inflation valve that allows gas from the direct feed into the bladders of the buoyancy compensator vest. A vent valve allows gas to escape from the bladders of the vest as desired by the diver. The vest may further have an over-pressurization valve that automatically vents the air bladders if the diver overinflates the buoyancy compensator by sending or by injecting too much gas. The vest includes a harness that the diver wears with straps around the torso and over the shoulders, and a plastic or metal back plate used to support one or more diving cylinders.

The buoyancy compensator vest further includes an integrated weight system, which typically includes a pouch for the insertion of weights such as lead weights with a click-release mechanism for quick removal of the integrated weight system. Removal of the integrated weight system allows for the providing of extra buoyancy in the event of an emergency such as if the diver needs to quickly surface in an emergency situation. When under water, a diver often needs to be neutrally buoyant so that the diver neither sinks nor rises, but remains at a constant depth with minimal effort. A state of neutral buoyancy exists when the weight of water that the diver displaces equals the total weight of the diver. The diver uses the buoyancy compensator device to maintain this neutral buoyancy by adjusting the buoyancy compensator's air volume, and therefore its buoyancy in response to various effects, which alter the diver's overall volume or weight. To remain neutrally buoyant, gas is injected to the buoyancy compensator device when the diver is too heavy or is sinking and vented from the buoyancy compensator device when the diver is too buoyant or is rising.

### SUMMARY

An embodiment of a weight system for use with a buoyancy compensator device includes a rigid plate having a first side and a second side, a weight pouch attached to the first side of the rigid plate, and a flexible strip having a first end attached to the rigid plate. The weight system further includes a flotation device attached to a second end of the flexible strip, and an indicator attached to a portion of the flexible strip.

Another embodiment of a weight system for use with a buoyancy compensator device includes a rigid plate, a weight pouch attached to the rigid plate, and an indicator device fixedly interfaced with the rigid plate. The indicator device further includes a freely moving floatation device that floats within a restrained range upward from the rigid plate in response to the weight pouch being separate from the buoyancy compensator device.

### BRIEF DESCRIPTION OF THE DRAWINGS

For a more complete understanding, reference is now made to the following description taken in conjunction with the accompanying Drawings in which:

FIG. 1A illustrates a front perspective view of the embodiment of the integrated weight system;

FIG. 1B illustrates a left-side view of the embodiment of the integrated weight system;

FIG. 1C illustrates a topside view of the embodiment of the integrated weight system;

FIG. 1D illustrates a bottom view of the embodiment of the integrated weight system;

FIG. 1E illustrates a backside view of the embodiment of the integrated weight system;

FIG. 1F illustrates a front-side view of the embodiment of the integrated weight system;

FIG. 2 illustrates a left-side, crosscut view of a portion of the embodiment of the integrated weight system;

FIG. 3 illustrates a left-side view of the embodiment of the integrated weight system in which the flexible strip is in a folded position;

FIG. 4A illustrates a front perspective view of an embodiment of a buoyancy compensator device for use with the integrated weight system;

FIG. 4B illustrates a front perspective view of the embodiment of the buoyancy compensator device having the integrated weight system disposed therein;

FIG. 5A is a left side view of the embodiment of the integrated weight system resting on a floor of a body of water;

FIG. 5B is a front side view of the embodiment of the integrated weight system resting on the floor of the body of water;

FIG. 6 illustrates an embodiment of an integrated weight system in which the flexible strip of the integrated weight system includes an active visual indicator as the indicator;

FIG. 7 illustrates another embodiment of an integrated weight system in which the flexible strip of the integrated weight system includes an active visual indicator as the indicator; and

FIG. 8 illustrates still another embodiment of an integrated weight system in which the flexible strip of the integrated weight system includes an active visual indicator as the indicator.

### DETAILED DESCRIPTION

Although the preferred embodiment has been described in detail, it should be understood that various changes, substitutions and alterations can be made therein without departing from the spirit and scope of the invention as defined by the appended claims.

Embodiments of the invention are directed to an integrated weight system having a visual indicator attached thereto for use with a buoyancy compensator device. The visual indicator in at least one embodiment, aids in the recovery of the integrated weight system subsequent to removal of the integrated weight system from the buoyancy compensator device, such as may be necessary in an emergency situation. In various embodiments, the indicator includes a flotation device, which functions to arrange the indicator in a more visible position when the integrated weight system is lying on an ocean floor or the floor of another body of water.

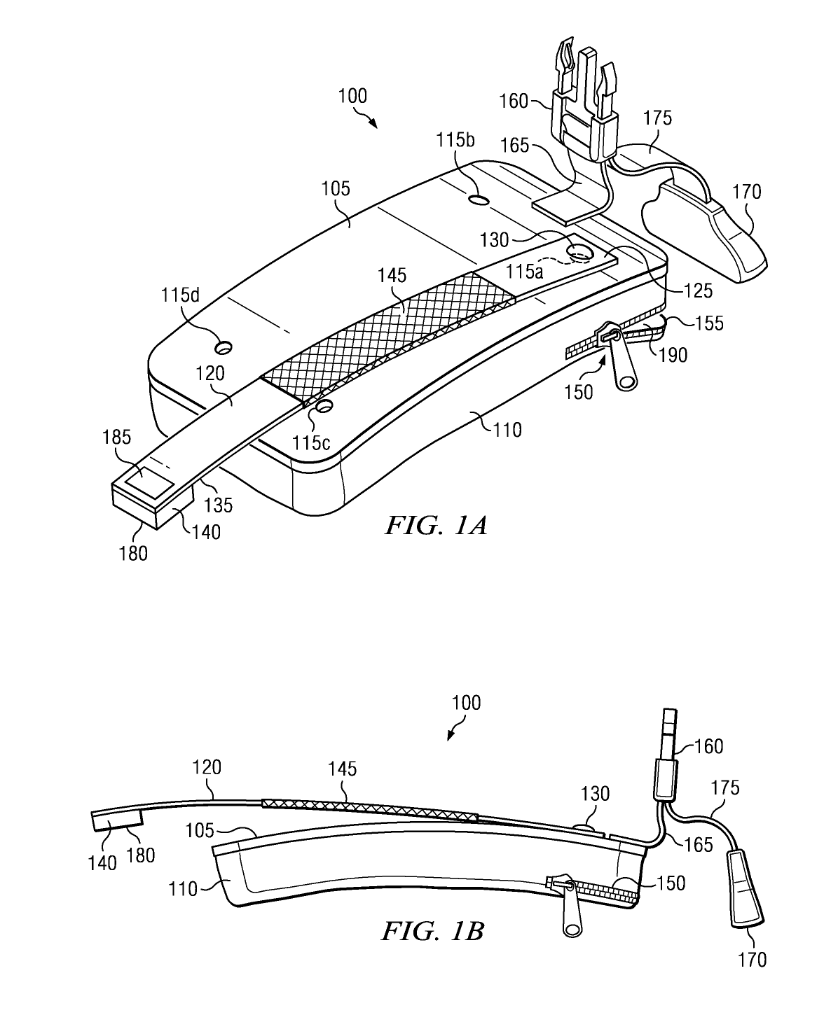

FIGS. 1A-1F illustrate various views of an embodiment of an integrated weight system 100. FIG. 1A illustrates a front perspective view of the embodiment of the integrated weight system 100. The integrated weight system 100 includes a rigid mounting plate 105 coupled to a weight pouch 110. The rigid mounting plate 105 in at least one embodiment is of a rectangular shape having rounded corners. In a particular embodiment, the rigid mounting plate 105 is formed of a plastic material. In at least one embodiment, the weight pouch 110 is of a lightweight flexible material such as nylon. In a particular embodiment, the weight pouch 110 is stitched to the edges of the rigid mounting plate 105 to form a pouch, which allows for the insertion of diving weights. In a particular embodiment, the weight pouch 110 is of a rectangular solid shape having rounded corners. In a particular embodiment, the rigid mounting plate 105 and weight pouch 110 are formed in a curved shape wherein the curve extends along the longest axis of the rigid mounting plate 105. In various embodiments, the weight pouch 110 may expand or be compressed in volume when accommodating one or more diving weights therein. The curved shape of the rigid mounting plate 105 and the weight pouch 110 allows them to conform to the shape of the diver's torso. The rigid mounting plate 105 further includes one or more drain holes 115A-115D extending therethrough into the interior portion 190 formed by the coupling of the rigid mounting plate 105 and the weight pouch 110. The drain holes 115A-115D allow a fluid such as water to flow into the weight pouch 110 during submergence and drain from the weight pouch 110 when the integrated weight system 100 is removed from water.

The integrated weight system 100 further includes a flexible strip 120 attached to the rigid mounting plate 105. In a particular embodiment, a first end 125 of the flexible strip 120 is attached to the rigid mounting plate 105 by a fastener 130 extending through the first end 125 of the flexible strip 120 and the drain hole 115A. In at least one embodiment, the flexible strip 120 is formed of a thin, flexible material such as vinyl and is in a substantially rectangular shape. In at least one embodiment, the flexible strip 120 is of a color to increase visibility of the flexible strip 120 when submerged in water. In a particular embodiment, the flexible strip 120 is of a red color. In still other embodiments, the flexible strip 120 may be of any other color having the characteristic of high visibility. A second end 135 of the flexible strip 120 is attached to a flotation device 140. The flexible strip 120 further includes an indicator 145 attached to a portion thereof. In various embodiments, indicator 145 functions to further increase the visibility of the integrated weight system 100 while submerged. The flotation device 140 possesses sufficient buoyancy to overcome the weight of the flexible strip 120 such when the integrated weight system 100 is free of attachment to a buoyancy compensator device and immersed within a body of water, the flexible strip 120 and indicator 145 is held at a substantially upright position. In at least one embodiment, the flexible strip 120 and indicator 145 form an indicator device fixedly interfaced with the rigid mounting plate 105 that includes a freely moving floatation device 140 that floats within a restrained range upward from the rigid mounting plate 105 in response to the weight pouch 110 being separate from a buoyancy compensator device.

In at least one embodiment, the indicator 145 comprises a passive visual indicator. The indicator 145 functions to increase visibility of the flexible strip 120 to an observer. In a particular embodiment, the indicator 145 is a light reflective tape extending along a portion of the length of the flexible strip 120. In at least one embodiment, the indicator 145 extends along a portion of one side of the flexible strip 120. In still another embodiment, the indicator 145 extends along portions of both sides of the flexible strip 120.

The integrated weight system 100 further includes a zipper assembly 150 extending along a portion of the weight pouch 110. Unzipping of the zipper assembly 150 by a user produces a pouch opening 155, which allows access to the interior portion 190 formed by the coupling of the rigid mounting plate 105 and the weight pouch 110. One or more diving weights may be placed within the interior portion 190, and the zipper assembly 150 may be zipped to secure the one or more diving weights therein. The weights of the one or more diving weights may be chosen by the diver to obtain a desired level of buoyancy. The integrated weight system further includes a male buckle portion 160 attached to the rigid mounting plate 105 via a first strap portion 165. The male buckle portion 160 is configured to be coupled to a female buckle portion of a buoyancy compensator device as will be further described herein. The integrated weight system 100 further includes a release handle 170 coupled to the male buckle portion 160 via a second strap portion 175. The release handle 170 is adapted to facilitate decoupling of the male buckle portion 160 from the female buckle portion of the buoyancy compensator device in a situation in which the diver wishes to quickly obtain more buoyancy. In a particular embodiment, the release handle 170 is of a high visibility color, such as red, to aid in locating and grasping of the release handle 170 by a diver.

In a particular embodiment, the flotation device 140 is of a closed-cell foam construction in the form of a rectangular solid. The closed-cell foam construction is sealed with a sealant such as an epoxy, silicone, clear-coat or other sealant in order to seal air trapped within the closed cells of the floatation device. The trapped air provides sufficient buoyancy to the flotation device 140 to overcome the weight of the flexible strip 120 when submerged in water. In a particular embodiment, the flotation device 140 is attached to the second end of the flexible strip 120 by stitching. In still in another embodiment, the flotation device 140 is attached to the second end 135 of the flexible strip 120 via an adhesive. In at least one embodiment, the face of the flotation device 140 includes a logo 180. In various embodiments, the logo 180 may identify a manufacturer or supplier of the integrated weight system 100. In still other embodiments, the logo 180 may identify a business that has rented the integrated weight system 100 to the diver. The integrated weight system 100 may further include a label 185 attached to the second end 135 of the flexible strip 120 on a side of the flexible strip 120 opposite that of the flotation device 140. In particular embodiments, the label 185 may include a textual description of a manufacturer, supplier or rental service of the integrated weight system 100. For example, the label 185 may identify a website, business name or phone number associated with the integrated weight system 100. In still other embodiments, the label 185 may be used to identify an owner of the integrated weight system 100.

FIG. 1B illustrates a left-side view of the embodiment of the integrated weight system 100. As illustrated in FIG. 1B, the embodiment of the integrated weight system 100 is of a generally curved shape to substantially conform to the shape of a buoyancy compensator device when worn by a user. FIG. 1C illustrates a topside view of the embodiment of the integrated weight system 100. As can be seen in the embodiment of FIG. 1C, the length of the flexible strip 120 is greater than the length of the longest axis of the rigid mounting plate 105. In still other embodiments, the flexible strip 120 may be constructed of any desired length. FIG. 1D illustrates a bottom view of the embodiment of the integrated weight system 100. FIG. 1E illustrates a backside view of the embodiment of the integrated weight system 100. FIG. 1F illustrates a front-side view of the embodiment of the integrated weight system 100.

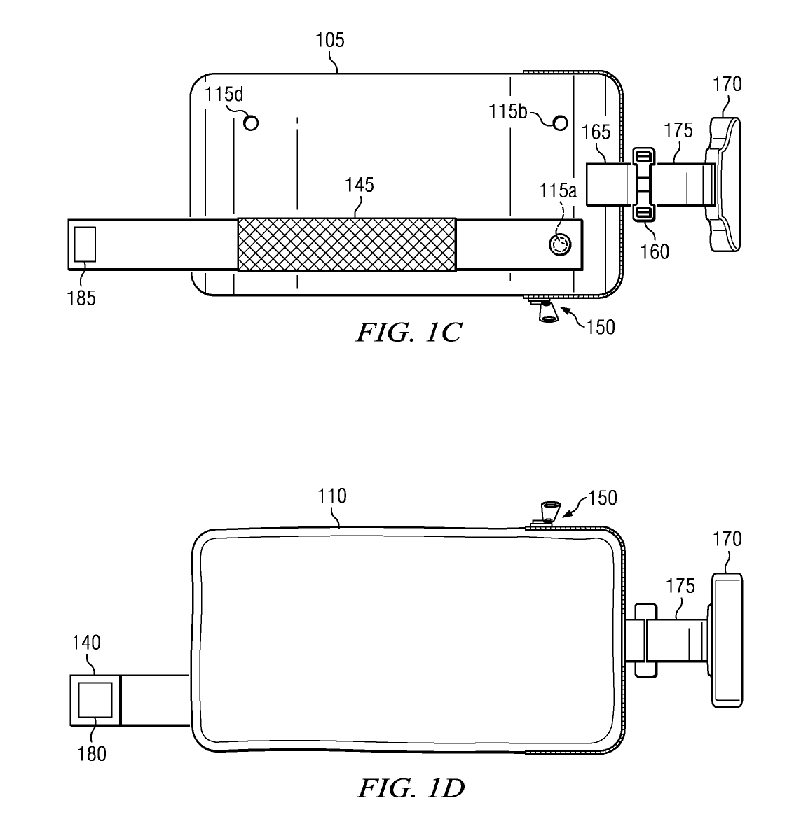

FIG. 2 illustrates a left-side, crosscut view of a portion of the embodiment of the integrated weight system 100. As illustrated in FIG. 2, the first end 125 of the flexible strip 120 is attached to the rigid mounting plate 105 via a fastener 130, which extends through the flexible strip 120 and the drain hole 115a into the interior portion 190 of the weight pouch 110. Although in the particular embodiment illustrated, the flexible strip 120 is attached to the drain hole 115a of the rigid mounting plate 105, it should be understood that in other embodiments, the flexible strip 120 may be attached to any portion of the rigid mounting plate 105 without requiring use of one or more of the drain holes 115a-115d. For example, in a particular embodiment, the flexible strip 120 may be attached to the rigid mounting plate proximate to the first strip portion 165, or alternately, at the opposing end or a middle portion of the rigid mounting plate 105. In still other embodiments, the flexible strip 120 may be attached to any other portion of the integrated weight system 100, such as the weight pouch 110. In still other embodiments, a plurality of flexible strips 120, each having one or more indicators 145 may be attached to various portions of the integrated weight system 100.

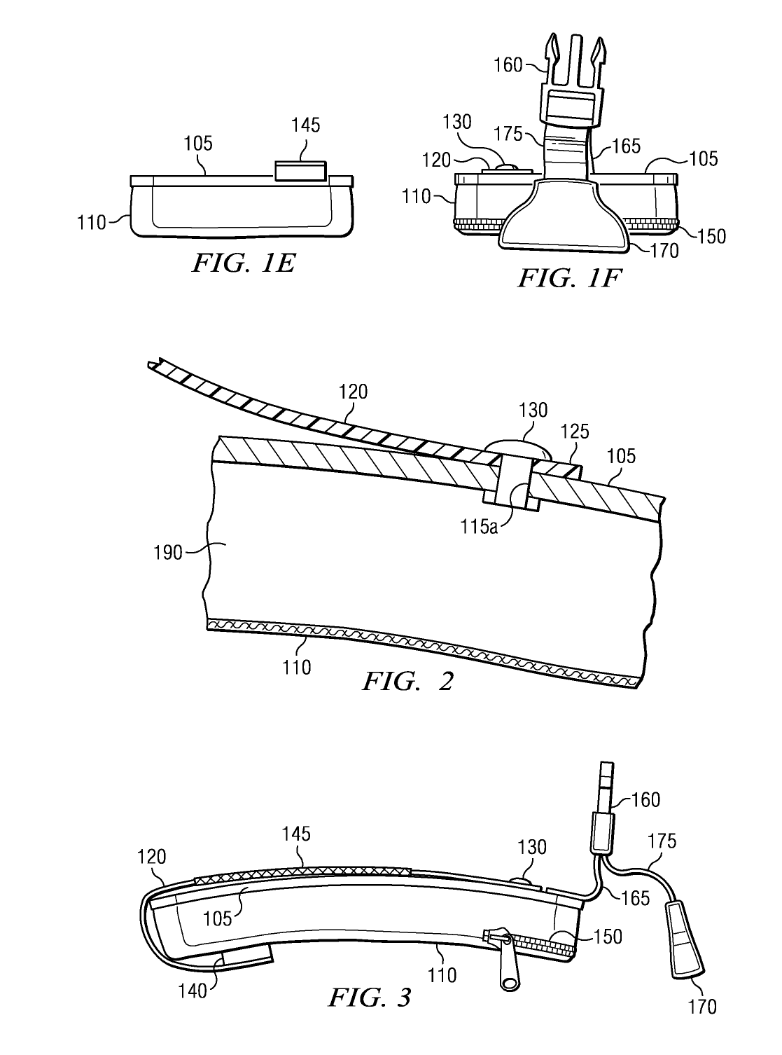

FIG. 3 illustrates a left-side view of the embodiment of the integrated weight system 100 in which the flexible strip 120 is in a folded position. In order to insert the integrated weight system 100 into a buoyancy compensator device, the flexible strip 120 is placed in a folded position. In the embodiment illustrated by FIG. 3, the flexible strip 120 is extended along the top surface of the rigid mounting plate 105 around the end opposite the male buckle portion 160 and along a portion of the surface of the weight pouch 110 in order to be placed in the folded position. In still other embodiments, the flexible strip 120 may be folded along a portion of its length and back upon itself along the rigid mounting plate 105 such that the flotation device 140 is proximate the male buckle portion 160. In still other embodiments, the flexible strip 120 may be folded a multiple of times about itself such that the flotation device 140 is disposed along any portion of the rigid mounting plate 105.

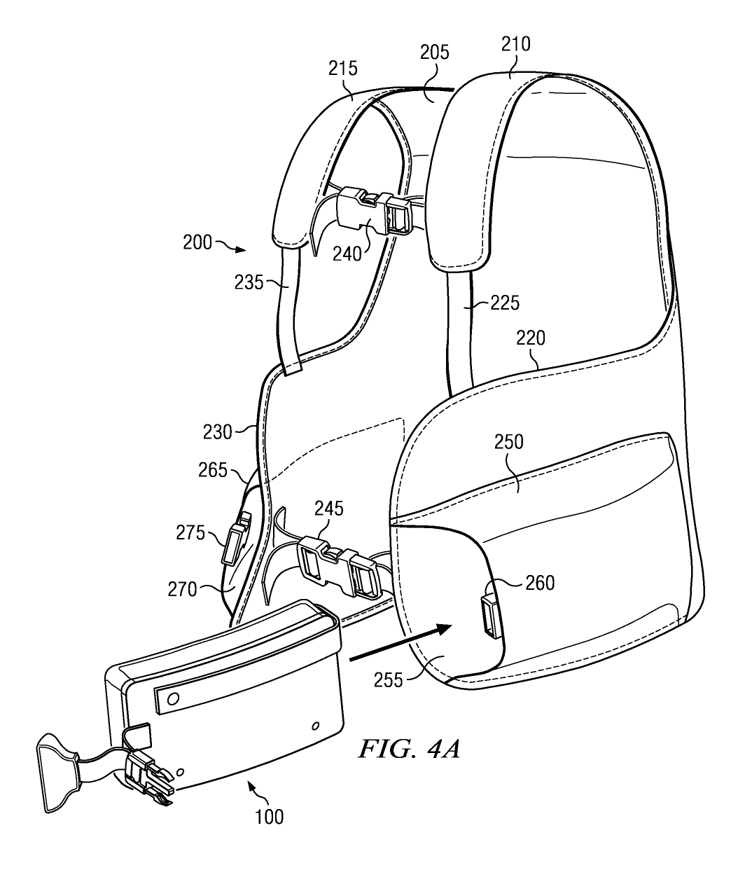

FIG. 4A illustrates a front perspective view of an embodiment of a buoyancy compensator device 200 for use with the integrated weight system 100. In a particular embodiment, the buoyancy compensator device 200 is a buoyancy compensator vest. In still other embodiments, the buoyancy compensator device 200 may include any type of buoyancy compensation device used by divers. The buoyancy compensator device 200 includes a back portion 205, which extends along the back portion of the torso of a diver when worn. The buoyancy compensator device 200 includes a left shoulder portion 210 attached to a left side of the back portion 205 and a right shoulder portion 215 attached to a right side of the back portion 205. The buoyancy compensator device 200 further includes a left lower portion 220 attached to a left side of the back portion 205 and a right lower portion 230 attached to the right side of the back portion 205. The left shoulder portion 210 is configured to extend over the shoulders and down a left portion of the torso of the diver, and the right shoulder portion 215 is configured to extend over the right shoulder and down a portion of the right-front torso of the diver. The left shoulder portion 210 is coupled to the left lower portion 220 via a left strap 225. The left lower portion is configured to cover and extend along a left side of the torso of the diver to a left lower portion of the torso of the diver. The right lower portion 230 is configured to cover and extend along a right side torso portion of the diver to a right lower front portion of the diver's torso. The right shoulder portion 215 is coupled to the right lower portion 230 via a right strap 235.

The buoyancy compensator device 200 further includes a chest buckle 240, which may be coupled together to connect the left shoulder portion 210 to the right shoulder portion 215 across or proximate to the chest of the diver. The buoyancy compensator device 200 further includes a waist buckle 245, which may be coupled together to connect the left lower portion 220 to the right lower portion 230 proximate to the waist of the diver.

The buoyancy compensator device 200 further includes a left weight pocket 250 formed in the left lower portion 220. The left weight pocket 250 includes a left weight pocket opening 255. The left weight pocket 250 is sized to accommodate insertion of the integrated weight system 100. A left buckle portion 260 is attached to the buoyancy compensator device 200 proximate to the left weight pocket opening 255. In at least one embodiment, the left female buckle portion 260 is attached at the left weight pocket opening 255. The left female buckle portion 260 is configured to be coupled to the male buckle portion 160 of the integrated weight system 100 upon insertion of the integrated weight system 100 into the left weight pocket opening 255. The buoyancy compensator device 200 may further include a right weight pocket 265 formed in the right lower portion 230. The right weight pocket 265 having a right weight pocket opening 270 and a right female buckle portion 275 attached proximate thereto. In the embodiment illustrated in FIG. 4A, the integrated weight system 100 is placed in a folded position such as described in FIG. 3, and is ready for insertion into the left weight pocket 250. Another integrated weight system 100 may be placed into the right weight pocket 265. However, for simplicity of description, only the left weight pocket 250 will be discussed herein. The integrated weight system 100 is inserted into the left weight pocket 250 through the left weight pocket opening 255, and the male buckle portion of the integrated weight system 100 is coupled to the left female buckle portion 260. The integrated weight system 100 is thereby retained within the left weight pocket 250 until it is desired to be removed by the diver.

FIG. 4B illustrates a front perspective view of the embodiment of the buoyancy compensator device 200 having the integrated weight system 100 disposed therein. In the illustration of FIG. 4B, the integrated weight system 100 has been inserted into the left weight pocket 250 of the buoyancy compensator device 200, with the flexible strip 120 placed within a folded position and retained within the left weight pocket 250. As previously discussed, a corresponding integrated weight system 100 may be placed within the right weight pocket 270 of the buoyancy compensator device 200. When it is desired by the diver that the integrated weight system 100 be removed from the buoyancy compensator device 200, such as in an emergency situation in which additional buoyancy is desired, the diver grasps the release handle 170 and pulls it in a direction toward the middle of the diver's torso. As a result, the male buckle portion 160 of the integrated weight system 100 is decoupled from the left female buckle portion 260 of the buoyancy compensator device 200. The diver may then let go of the release handle 170 and allow the integrated weight system 100 to fall to the floor of the body of water in which the diver is diving. Upon releasing of the integrated weight system 100, the diver is free to surface and later retrieve the integrated weight system 100 from the floor of the body of water with the aid of the indicator 145 as will be further described.

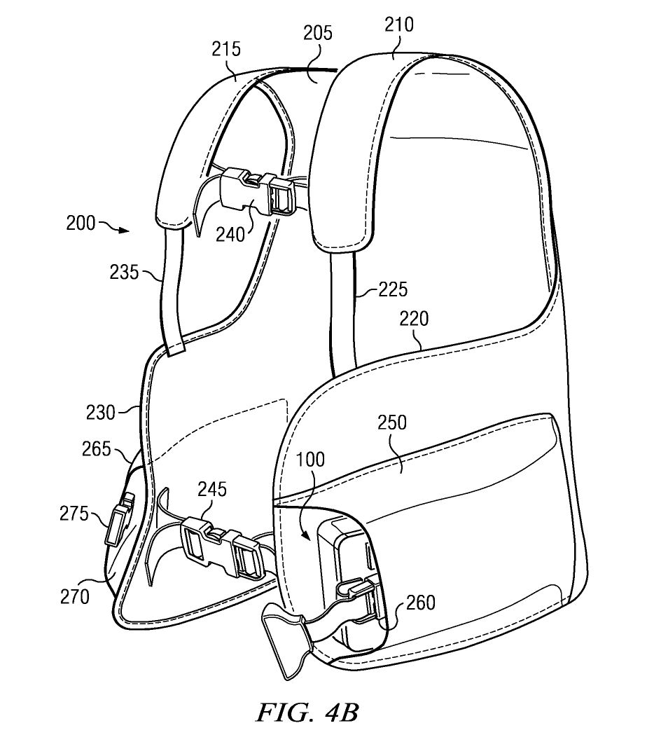

FIG. 5A is a left side view of the embodiment of the integrated weight system 100 resting on a floor 505 of a body of water 510. FIG. 5B is a front side view of the embodiment of the integrated weight system 100 resting on the floor 505 of the body of water 510. As seen in FIGS. 5A-5B, the flotation device 140 possesses enough buoyancy to hold the flexible strip 120 in a substantially upright position. The indicator 145 provides a visual indication to one or more persons searching for the integrated weight system 100 within the body of water 510. The indicator 145 allows a searcher to more easily locate the integrated weight system 100 from a distance when the integrated weight system 100 is within the body of water 510. The searcher may then retrieve the integrated weight system 100 from the floor 505 of the body of water 510. Accordingly, the integrated weight system 100 may be reused by a diver during a subsequent diving operation. Although the particular embodiment illustrated herein includes a light reflective portion functioning as the indicator 145, it should be understood that other types of passive indicators may be used. In still other embodiments, an active visual indicator may be used for the indicator 145 as will be further described herein.

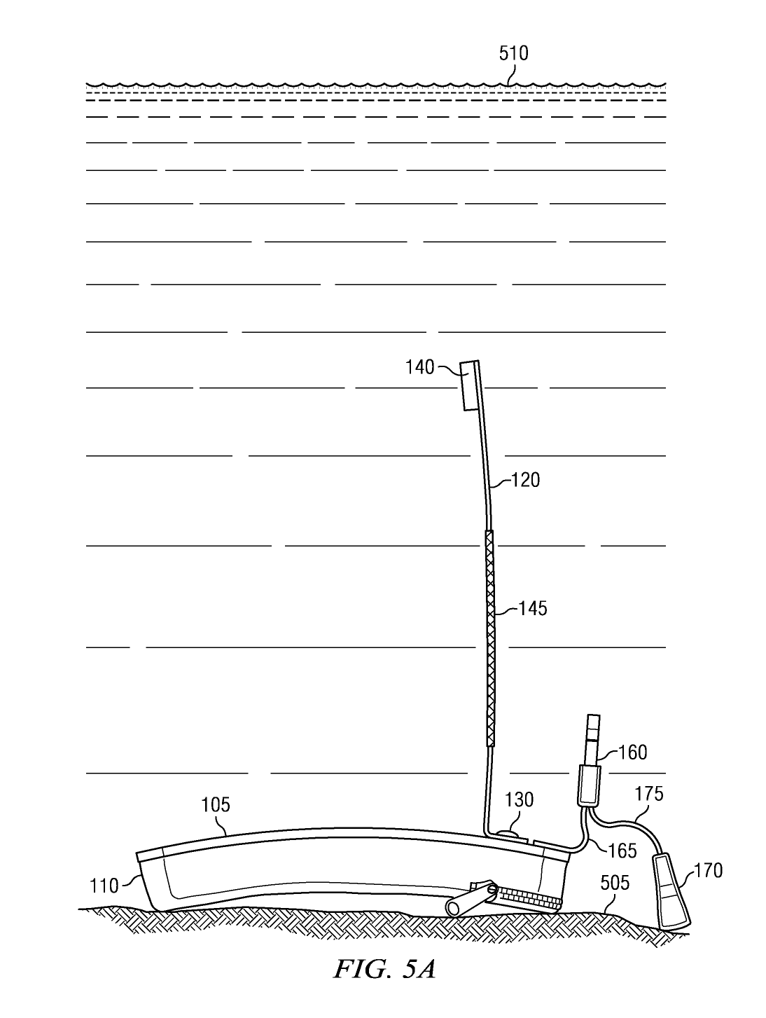

FIG. 6 illustrates an embodiment of an integrated weight system 600 in which the flexible strip 120 of the integrated weight system 600 includes an active visual indicator as the indicator 145. In the embodiment illustrated in FIG. 6, the indicator 145 is an active visual indicator comprised of one or more illumination devices 605a-605e extending along a portion of the flexible strip 120. An active visual indicator may allow a searcher to more easily located the integrated weight system 100 within a body of water as well as increase the distance at which the integrated weight system 100 may be observed. In at least one embodiment, the one or more illumination devices are light emitting diodes (LEDs). The light illumination devices 605A-605E are coupled to a power source 610 disposed proximate to the rigid mounting plate 105 via an electrical connection 615. In a particular embodiment, the power source 610 is a battery, and the electrical connection 615 is one or more electrical traces or wires. In at least one embodiment, one or more of the power source 610 and the electrical connection 615 are protected by a water-tight seal. In at least one embodiment, the illumination devices 605a-605e are activated upon unfolding of the flexible strip 120 from the folded position. In still other embodiments, the illumination devices 605a-605e may be continually illuminated as long as the battery source 610 retains sufficient power to do so. In still other embodiments, a switch may be provided to allow activation of the illumination devices 605a-605e when desired by the user. In at least one embodiment, the one or more illumination devices 605a-605e may be configured to illuminate in a predetermined pattern. In a particular embodiment, the predetermined pattern may consist of a periodic flashing on and off of one or more of the illumination devices 605a-605e. In at least one embodiment, the illumination devices 605a-605e may be arranged in a linear manner along a portion of the flexible strip 120. In a particular embodiment, the illumination devices 605a-605e may illuminate in a sweeping pattern or blinking pattern to further aid in location and identification of the integrated weight system 100. By illuminating the one or more illumination devices 605a-605e in a predetermined pattern, the ability of a searcher to locate the integrated weight system 100 within a body of water may be increased.

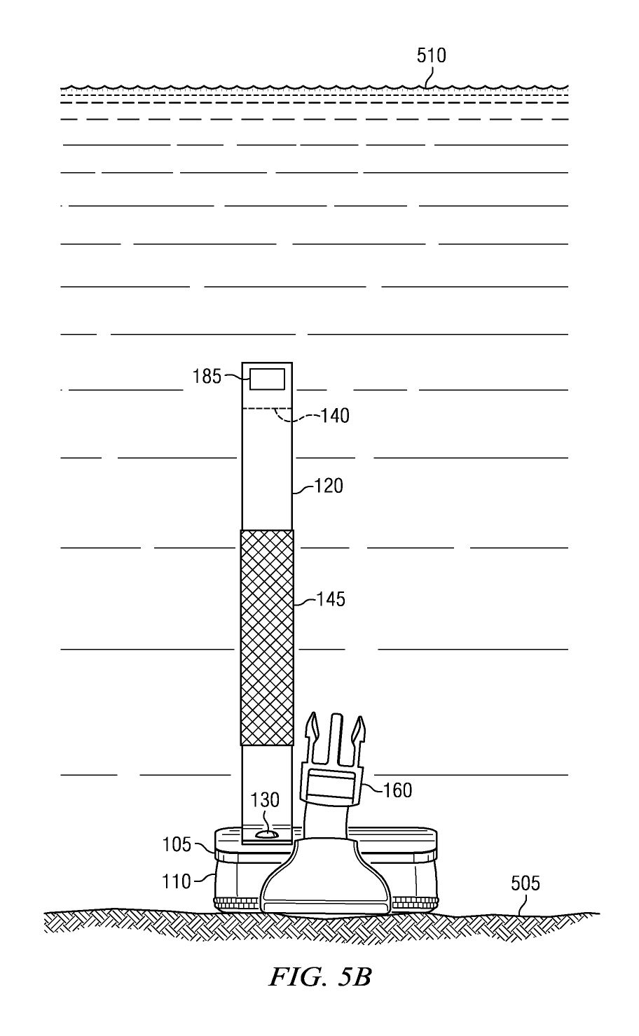

FIG. 7 illustrates another embodiment of an integrated weight system 700 in which the flexible strip 120 of the integrated weight system 700 includes an active visual indicator as the indicator 145. In the embodiment illustrated in FIG. 7, the flexible strip 120 is replaced with a flexible strip 720, which comprises a flexible tube having a substantially circular cross section constructed of a transparent or semi-transparent material. The flexible strip 720 has one or more illumination devices 705a-705e disposed within. The illumination devices 705-705e are coupled to a power source 710, such as a battery, via an electrical connection 715. In a particular embodiment, the illumination devices 705-705e are LEDs. In the embodiment illustrated in FIG. 7, the flexible strip 720 may be coiled prior to being inserted within a buoyancy compensator device 200, and then uncoiled upon removal therefrom. In a particular embodiment, the illumination devices 705a-705e may be configured to illuminate in a predetermined pattern. In still other embodiments, the illumination devices 705a-705e may be configured to illuminate continuously or under control by a user.

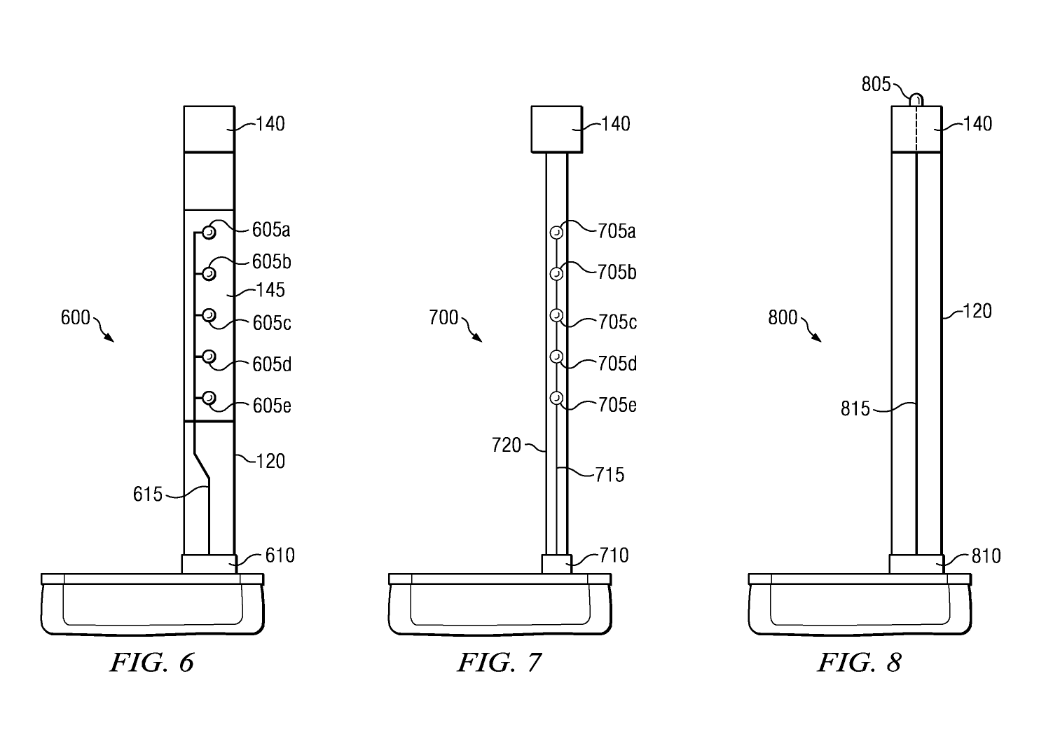

FIG. 8 illustrates still another embodiment of an integrated weight system 800 in which the flexible strip 120 of the integrated weight system 800 includes an active visual indicator as the indicator 145. In the embodiment illustrated in FIG. 8, one or more illumination devices 805 are attached at the second end 135 of the flexible strip 120 proximate to or attached to the flotation device 140. The one or more illumination devices 805 may be coupled to a power source 810 proximate to the first end 125 of the flexible strip 120 via an electrical connection 815. In a particular embodiment, the illumination device 805 is an LED. In at least one embodiment, the one or more illumination devices 805 may be configured to illuminate in a predetermined pattern. In other embodiments, the power source 810 may be attached proximate to the flotation device 140 instead of near the first end 125 of the flexible strip 120.

Although various embodiments of the indicator have been described with respect to an integrated weight system, it should be understood that in other embodiments the indicator described herein may be attached to or used with any type of weight system or weight device. For example, in a particular embodiment the various embodiments of the indicator may be attached to a weight belt.

It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A weight system for use with a buoyancy compensator device comprising:
a rigid plate having a first side and a second side;
a weight pouch attached to the first side of the rigid plate;
a flexible strip having a first end attached to the rigid plate;
a flotation device attached to a second end of the flexible strip; and
an indicator attached to a portion of the flexible strip.

2. The weight system of claim 1, wherein the indicator comprises a visual indicator.

3. The weight system of claim 1, wherein the indicator comprises a passive visual indicator.

4. The weight system of claim 3, wherein the passive visual indicator comprises a light reflective tape extending along a portion of the flexible strip.

5. The weight system of claim 3, wherein the passive visual indicator extends along a portion of at least one side of the flexible strip.

6. The weight system of claim 1, wherein the indicator comprises an active visual indicator.

7. The weight system of claim 6, wherein the active visual indicator comprises at least one illumination device attached to a portion of the flexible strip.

8. The weight system of claim 7, wherein the at least one illumination device is configured to illuminate in a predetermined pattern.

9. The weight system of claim 8, wherein the predetermined pattern comprises a periodic flashing on and off of the at least one illumination device.

10. The weight system of claim 7, wherein the at least one illumination device comprises a light emitting diode (LED).

11. The weight system of claim 6, wherein the active visual indicator comprises a plurality of illumination devices arranged along a portion of at least one side of the flexible strip.

12. The weight system of claim 11, wherein the plurality of illumination devices are linearly arranged along the portion of the flexible strip.

13. The weight system of claim 11, wherein the plurality of illumination devices are configured to illuminate in a predetermined pattern.

14. The weight system of claim 1, wherein the flotation device includes a closed-cell foam portion, the closed-cell foam portion being substantially sealed with a sealant.

15. The weight system of claim 1, wherein the rigid plate includes at least one drain hole, and wherein the first end of the flexible strip is attached to the rigid plate via a fastener extending through the first end of the flexible strip and the at least one drain hole.

16. The weight system of claim 1, wherein the buoyancy compensator device includes at least one weight pocket, and wherein the weight system is configured to be placed within the at least one weight pocket.

17. The weight system of claim 16, wherein the buoyancy compensator device includes at least one female buckle portion attached thereto in proximity to the at least one weight pocket.

18. The weight system of claim 17, further comprising a male buckle portion attached to the rigid plate, the male buckle portion configured to be coupled to the at least one female buckle portion of the buoyancy compensator device.

19. The weight system of claim 18, further comprising a release handle coupled to the male buckle portion, the release handle adapted to facilitate decoupling of the male buckle portion of the weight system from the female buckle portion of the buoyancy compensator device.

20. The weight system of claim 1, wherein the weight pouch is configured to hold at least one diving weight therein.

21. A weight system for use with a buoyancy compensator device comprising:
a rigid plate;
a weight pouch attached to the rigid plate; and
an indicator device fixedly interfaced with the rigid plate and including a freely moving floatation device that floats within a restrained range upward from the rigid plate in response to the weight pouch being separate from the buoyancy compensator device.
